(19) United States
(12) Patent Application Publication
(10) Pub. No.: US 2013/0330624 A1
(43) Pub. Date: Dec. 12, 2013

(54) LITHIUM TITANATE DOPED WITH BARIUM OXIDE, MANUFACTURING METHOD THEREOF AND LITHIUM ION BATTERY USING THE SAME

(71) Applicants: Xiaoping Zhou, Huzhou (CN); Lingyan Fu, Huzhou (CN)

(72) Inventors: Xiaoping Zhou, Huzhou (CN); Lingyan Fu, Huzhou (CN)

(73) Assignee: Microvast New Materials (Huzhou) Co., LTD., Huzhou City (CN)

(21) Appl. No.: 13/528,717

(22) Filed: Jun. 20, 2012

(30) Foreign Application Priority Data
Jun. 12, 2012 (CN) 201210193241.3

(51) Int. Cl. H01M 4/485; H01M 4/505; H01M 4/525

(52) U.S. Cl. 429/221; 252/182.1; 429/231.1; 429/231.3; 429/223; 429/224

(57) ABSTRACT

A lithium titanate doped with a barium oxide and a manufacturing method thereof are provided. At first, a barium source material, a lithium source material and a titanium source material are mixed together to prepare a mixture. Then, a drying process is applied to the mixture. Thereafter, a sintering process is applied to the mixture after the drying process, thereby obtaining the lithium titanate doped with the barium oxide. The lithium titanate doped with the barium oxide has the following chemical formula: BaₓLi₄Ti₅O₁₂₊ₓ, wherein 0.006≦x≦0.12. A lithium ion battery is also provided, which has an excellent cycling stability, a fast charge-discharge capability and a high safety performance.

### FIELD OF THE INVENTION

The present invention relates to a lithium ion battery, and particularly to a lithium titanate doped with a barium oxide, a method for manufacturing the lithium titanate doped with the barium oxide, and a lithium ion battery having a negative electrode including the lithium titanate doped with the barium oxide.

### BACKGROUND OF THE INVENTION

Lithium ion battery is widely used because of its properties of high specific energy, high voltage and low pollution. Generally, a material of a negative electrode of lithium ion battery includes, for example, carbon-based materials, nitride, silicon-based materials, tin-based materials and alloys. Currently, only the carbon-based materials are used in practical products, and other materials such as nitride, silicon-based materials, tin-based materials and alloys are still in a laboratory research stage.

In the late 1980s, lithium titanate (Li₄Ti₅O₁₂, or LTO) has been researched to be used as a material of a positive electrode of the lithium ion battery. However, an electric potential of the lithium titanate is lower than an electric potential of a lithium metal, and an energy density of the lithium titanate can not meet the energy density demand of the lithium ion battery. For example, a theoretical specific capacity of the lithium titanate is 175 milliampere-hour per gram (mAh/g). Therefore, it is found that the lithium titanate is not suitable for being used as the material of the positive electrode of the lithium ion battery. In the early 1990s, Ohzuku et al. developed a simulated battery including a negative electrode comprised of the lithium titanate and a positive electrode comprised of lithium cobaltate and researched its electrochemical properties. It is reported that the lithium titanate has a “zero strain” insertion material. The negative electrode comprised of the lithium titanate has a high electrode voltage, for example, 1.55V, thereby avoiding an electrolyte decomposition phenomena or avoiding forming a protective film. A charge-discharge efficiency of the simulated battery after the first time charge-discharge cycle is up to 90% or more. Further, because the lithium titanate can remain a stable crystal structure in charge-discharge cycles, the negative electrode comprised of the lithium titanate can provide a stable charge-discharge platform so as to maintain an excellent cycling stability. In particular, because the skeleton structure of the lithium titanate is almost not changed in fast charge and discharge conditions, the lithium ion battery using the lithium titanate as the negative electrode can serve as an electric vehicle power. In addition, the lithium ion battery using the lithium titanate as the negative electrode has a better safety performance. Therefore, the lithium titanate has get most of attention and is considered to be the greatest potentiality next-generation negative material of the lithium ion battery.

However, the lithium titanate is an insulating material and the electronic conductivity is poor. In a high-rate charge-discharge condition, a capacity fading of the lithium ion battery is fast. Further, with the increase of the charging-discharging cycle number, the lithium ion battery will generate a swelling phenomenon. Moreover, in a high temperature condition, with the increase of the charging-discharging cycle number, the swelling velocity of the lithium ion battery is very fast, which will cause a rapid decline of the capacity of lithium ion battery.

### SUMMARY OF THE INVENTION

The present invention is directed to a lithium titanate doped with barium oxide, which can be used as a negative electrode material of a lithium ion battery. The lithium ion battery has an excellent cycling stability, a fast charge-discharge capability and a high safety performance.

The present invention is further directed to a method of manufacturing a lithium titanate doped with a barium oxide. The lithium titanate doped with the barium oxide manufactured by the method can be used as a negative electrode material of a lithium ion battery. The lithium ion battery has an excellent cycling stability, a fast charge-discharge capability and a high safety performance.

The present invention is also directed to a lithium ion battery having an excellent cycling stability, a fast charge-discharge capability and a high safety performance.

The present invention provides a lithium titanate doped with a barium oxide, which has the following chemical formula: BaₓLi₄Ti₅O₁₂₊ₓ, wherein x is a mole number, and 0.006≦x≦0.12.

The present invention further provides a method of manufacturing a lithium titanate doped with a barium oxide. At first, a barium source material, a lithium source material and a titanium source material are mixed together to prepare a mixture. Then, a drying process is applied to the mixture. Thereafter, a sintering process is applied to the mixture after the drying process, thereby obtaining the lithium titanate doped with the barium oxide. The lithium titanate doped with the barium oxide has the following chemical formula: BaₓLi₄Ti₅O₁₂₊ₓ, wherein 0.006≦x≦0.12.

In one embodiment of the method of manufacturing the lithium titanate doped with the barium oxide, the barium source material is at least one of barium hydroxide, barium carbonate, barium oxide and organic barium salt. The organic barium salt is at least one of barium oxalate and barium acetate.

In one embodiment of the method of manufacturing the lithium titanate doped with the barium oxide, the lithium source material is at least one of lithium hydroxide, lithium carbonate and organic lithium salt. The organic lithium salt is at least one of lithium oxalate and lithium acetate

In one embodiment of the method of manufacturing the lithium titanate doped with the barium oxide, the titanium source material is at least one of titanium oxide, metatitanic acid and organic titanate. The organic titanate is at least one of isopropyl titanate and n-butyl titanate.

In one embodiment of the method of manufacturing the lithium titanate doped with the barium oxide, the drying temperature of drying the mixture is in a range from 80 to 120° C., the sintering temperature of sintering the mixture is in a range from 450 to 1000° C., preferably, from 500 to 900° C.

The present invention also provides a lithium ion battery including a positive electrode, a negative electrode, a separator between the positive electrode and the negative electrode, and an electrolyte. The negative electrode includes a lithium titanate doped a barium oxide. The lithium titanate doped with the barium oxide has the following chemical formula: BaₓLi₄Ti₅O₁₂₊ₓ, wherein 0.006≦x≦0.12.

In the present invention, the lithium titanate is doped with the barium oxide to form the lithium titanate doped the barium oxide. When the lithium titanate doped with the barium oxide is used as the negative electrode material of the lithium ion battery, the barium in the lithium titanate can reduce the swelling velocity of the lithium ion battery, thereby improving the cycling stability and the cycling life. The capacity retention rate of the lithium ion battery is not less than 80% after 2250 charge-discharge cycles at 60° C. and at 6C charge-discharge rate. Thus, the lithium titanate doped the barium oxide can be used as the negative electrode material of the lithium ion battery serving as an electric vehicle power. In addition, the method of manufacturing the lithium titanate doped with the barium oxide is very simple and is easy to be industrialized. The lithium ion battery has an excellent cycling stability, a fast charge-discharge capability and a high safety performance.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 illustrates a process flow of a method manufacturing a lithium titanate doped with a barium oxide in accordance with an embodiment of the present invention.

FIG. 2 illustrates a charge-discharge curve graph of soft-package lithium ion batteries of example 4 and comparison example 2 at 60° C. and at 6C charge-discharge rate.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

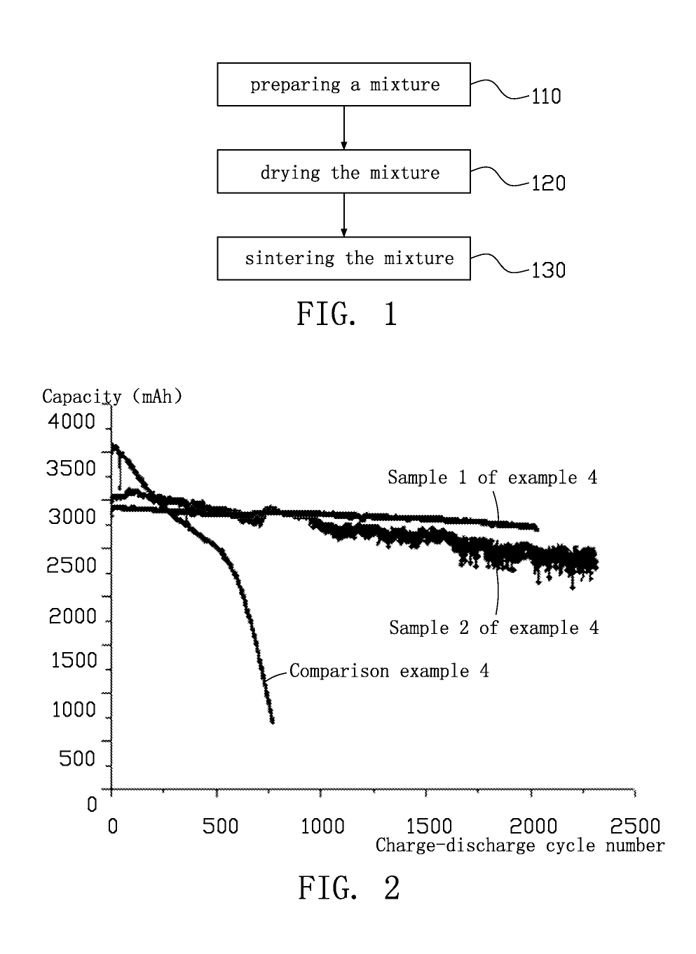

FIG. 1 illustrates a process flow of a method manufacturing a lithium titanate doped with a barium oxide in accordance with an embodiment of the present invention. In the present embodiment, at first, a barium source material, a lithium source material and a titanium source material are mixed together in a specific ratio to prepare a mixture. Then, a drying process is applied to the mixture. Thereafter, a sintering process is applied to the mixture after the drying process, thereby obtaining the lithium titanate doped with the barium oxide.

In detail, referring to FIG. 1, a mixing process 110 is performed. The barium source material, the lithium source material and the titanium source material are mixed together in a specific ratio to prepare the mixture. The barium source material, the lithium source material and the titanium source material respectively refer to a material containing barium atoms, a material containing lithium atoms and a material containing titanium atoms. In the present embodiment, the barium source material, the lithium source material and the titanium source material is determined by a molar ratio of metal atoms in the barium source material, the lithium source material and the titanium source material. In other words, in the present embodiment, a molar ratio of the barium atoms in the barium source material, the lithium atoms in the lithium source material and the titanium atoms in the titanium source material (Ba:Li:Ti) is (0.006˜0.12):4:5. The barium source material, the lithium source material and the titanium source material can be mixed by, but not limited to, a solution mixing method, a ball-milling mixing method or mechanical mixing method. A mixing time of mixing the barium source material, the lithium source material and the titanium source material is, for example, in a range from 2 to 6 hours. The barium source material can be at least one of barium hydroxide (Ba(OH)₂), barium carbonate (BaCO₃), barium oxide (BaO) and organic barium salts. The organic barium salts can be at least one of barium oxalate (BaC₂O₄) and barium acetate (Ba(CH₃COO)₂). Other suitable organic barium salts can also be used. The lithium source material can be at least one of lithium hydroxide (LiOH), lithium carbonate (Li₂CO₃), and organic lithium salts. The organic acid lithium salts can be at least one of lithium oxalate (Li₂C₂O₄) and lithium acetate (LiCH₃COO). Other suitable organic lithium salts can also be used. The titanium source material can be at least one of titanium oxide (TiO₂), metatitanic acid (H₂TiO₃) and organic titanates. The organic titanates can be at least one of isopropyl titanate and n-butyl titanate.

Next, a drying process 120 is applied to the mixture prepared in the mixing process 110. The mixture prepared in the mixing process 110 can be dried by, but not limited to, a baking method, a freeze-drying method and spray drying method. A drying temperature is, for example, in a range from 80 to 120° C.

Next, a sintering process 130 is applied to the mixture after the drying process 120. For example, the mixture after the drying process 120 can be sintered in a sintering furnace. A sintering temperature is, for example, in a range from 450 to 1000° C. Preferably, a sintering temperature is, for example, in a range from 500 to 900° C. A sintering time is, for example, in a range from 1 to 10 hours. Next, the lithium titanate doped with the barium oxide can be obtained after the sintered mixture is cooled down to the room temperature naturally. The lithium titanate doped with the barium oxide has the following chemical formula: BaₓLi₄Ti₅O₁₂₊ₓ, wherein x is a mole number, 0.006≦x≦0.12. In the lithium titanate doped with the barium oxide, a weight ratio of the barium oxide and the lithium titanate can be calculated. For example, the weight ratio of the barium oxide and the lithium titanate is in a range from 0.2% to 4.0%. Preferably, the weight ratio of the barium oxide and the lithium titanate is in a range from 1.0% to 3.0%.

In one embodiment, the lithium titanate doped with the barium oxide can be manufactured by the following method. At first, a barium source material such as Ba(OH)₂, a lithium source material such as LiOH, and a titanium source material such as TiO₂ are mixed together in a specific ratio to prepare a mixture. Then, a drying process is applied to the mixture. Thereafter, a sintering process is applied to the mixture after the drying process, thereby obtaining the lithium titanate doped with the barium oxide. BaₓLi₄Ti₅O₁₂₊ₓ, wherein 0.006≦x≦0.12.

In another embodiment, the lithium titanate doped with the barium oxide can be manufactured by the following method. At first, a barium source material such as BaCO₃, BaO or Ba(OH)₂, a lithium source material such as LiCO₃, Li₂C₂O₄ or LiCH₃COO, and a titanium source material such as organic titanate are mixed together in a specific ratio to prepare a mixture. The organic titanate can be the isopropyl titanate or the n-butyl titanate. Then, a drying process is applied to the mixture. Thereafter, a sintering process is applied to the mixture after the drying process, thereby obtaining the lithium titanate doped with the barium oxide. BaₓLi₄Ti₅O₁₂₊ₓ, wherein 0.006≦x≦0.12.

In still another embodiment, the lithium titanate doped with the barium oxide can be manufactured by the following method. At first, a barium source material such as organic barium salt, a lithium source material such as organic lithium salt, and a titanium source material such as TiO₂, H₂TiO₃ or organic titanate are mixed together in a specific ratio to prepare a mixture. The organic barium salt can be, for example, BaC₂O₄), Ba(CH₃COO)₂ or other suitable organic barium salts. The organic lithium salt can be, for example, Li₂C₂O₄, LiCH3COO or other suitable organic lithium salts can also be used. The organic titanate can be the isopropyl titanate or the n-butyl titanate. Then, a drying process is applied to the mixture. Thereafter, a sintering process is applied to the mixture after the drying process, thereby obtaining the lithium titanate doped with the barium oxide. BaₓLi₄Ti₅O₁₂₊ₓ, wherein 0.006≦x≦0.12.

The lithium titanate doped with the barium oxide manufactured by the above method can be used as an active material of a negative electrode of a lithium ion battery. In one embodiment, a lithium ion battery includes a positive electrode, a negative electrode, a separator between the positive electrode and the negative electrode, and an electrolyte. The negative electrode includes the lithium titanate doped with the barium oxide. The lithium titanate doped with the barium oxide has the following chemical formula: BaₓLi₄Ti₅O₁₂₊ₓ, wherein 0.006≦x≦0.12. In addition, the positive electrode of the lithium ion battery can be lithium cobalt(III) oxide (LiCoO₂), lithium iron phosphate (LiFePO₄) or lithium multimetal oxide. The lithium multimetal oxide has the following formula: Li(M1ₓM2_{y}M3_{z}M4₁)O₂, wherein x+y+z+1=1, each of the M1, M2 and M3 is one of nickel (Ni), cobalt(Co), manganese (Mn) and iron (Fe), and M4 is aluminum (Al) or silicon (Si)). In addition, the separator, the electrolyte and the structure of the lithium ion battery are similar to a conventional lithium ion battery, and nor described here.

The following examples and comparison examples can prove the improvement of the electrochemical performance of the lithium ion battery using the lithium titanate doped with the barium oxide as the negative material.

### EXAMPLE 1

1280.4 g hydrated lithium hydroxide (LiOH.H₂O) with a purity of 98% and 3000 g TiO₂ with a purity of 99.5% are mixed into 3.0 liter(L) deionized water. After stirring, 214.8 g hydrated barium hydroxide Ba(OH)₂.8H₂O with a purity of 98% is further mixed into the mixing solution of LiOH.H₂O and TiO₂. After about 5 h stirring, a mixture can be obtained. Next, the mixture is dried by the spray-drying method. Next, the dried mixture is sintered at 750° C. for about 5 h. Then, the lithium titanate doped with the barium oxide can be obtained, which can be directly used as the negative material of the lithium ion battery. In this example, the lithium titanate doped with the barium oxide has the following chemical formula: BaₓLi₄Ti₅O₁₂₊ₓ, wherein x is equal to 0.09. In other words, the weight ratio of the barium oxide and the lithium titanate is 3.0%.

A button lithium ion battery is manufactured by the following steps. 1.200 g of the lithium titanate doped with the barium oxide, a certain amount of a conductive agent, an adhesive and n-methyl-2-pyrrolidone (NMP) are mixed for 4 h by a ball-milling method using a planet ball-milling machine, thereby obtaining a mixing powder. Then, the mixing powder is coated on an aluminum foil. A coating thickness of the mixing powder is about 150 micrometers (μm). After the aluminum foil coated with the mixing powder is dried in a vacuum condition, the aluminum foil coated with the mixing powder is cut into circular pieces, thereby forming the button lithium ion batteries. A diameter of each of the circular pieces is 8 millimeters (mm).

### EXAMPLE 2

1280.4 g hydrated lithium hydroxide (LiOH.H₂O) with a purity of 98% and 3000 g TiO₂ with a purity of 99.5% are mixed into 3.0 L deionized water. After stirring, 143.2 g hydrated barium hydroxide Ba(OH)₂.8H₂O with a purity of 98% is further mixed into the mixing solution of LiOH.H₂O and TiO₂. After about 5 h stirring, a mixture can be obtained. Next, the mixture is dried by the spray-drying method. Next, the dried mixture is sintered at 750° C. for about 5 h. Then, the lithium titanate doped with the barium oxide can be obtained, which can be directly used as the negative material of the lithium ion battery. In this example, the lithium titanate doped with the barium oxide has the following chemical formula: BaₓLi₄Ti₅O₁₂₊ₓ, wherein x is equal to 0.06. In other words, the weight ratio of the barium oxide and the lithium titanate is 2.0%.

A button lithium ion battery is manufactured by the following steps. 1.200 g of the lithium titanate doped with the barium oxide, a certain amount of a conductive agent, an adhesive and n-methyl-2-pyrrolidone (NMP) are mixed for 4 h by a ball-milling method using a planet ball-milling machine, thereby obtaining a mixing powder. Then, the mixing powder is coated on an aluminum foil. A coating thickness of the mixing powder is about 150 μm. After the aluminum foil coated with mixing powder is dried in a vacuum condition, the aluminum foil coated with the mixing powder is cut into circular pieces, thereby forming the button lithium ion batteries. A diameter of each of the circular pieces is 8 mm.

### EXAMPLE 3

1280.4 g hydrated lithium hydroxide (LiOH.₂O) with a purity of 98% and 3000 g TiO₂ with a purity of 99.5% are mixed into 3.0 L deionized water. After stirring, 71.6 g hydrated barium hydroxide Ba(OH)₂.8H₂O with a purity of 98% is further mixed into the mixing solution of LiOH.H₂O and TiO₂. After about 5 h stirring, a mixture can be obtained. Thereafter, the dried mixture is dried by the spray-drying method. Then, the mixture is sintered at 750° C. for about 5 h. Then, the lithium titanate doped with the barium oxide can be obtained, which can be directly used as the negative material of the lithium ion battery. In this example, the lithium titanate doped with the barium oxide has the following chemical formula: BaₓLi₄Ti₅O₁₂₊ₓ, wherein x is equal to 0.03. In other words, the weight ratio of the barium oxide and the lithium titanate is 1.0%.

A button lithium ion battery is manufactured by the following steps. 1.200 g of the lithium titanate doped with the barium oxide, a certain amount of a conductive agent, an adhesive and n-methyl-2-pyrrolidone (NMP) are mixed for 4 h by a ball-milling method using a planet ball-milling machine, thereby obtaining a mixing powder. Then, the mixing powder is coated on an aluminum foil. A coating thickness of the mixing powder is about 150 μm. After the aluminum foil coated with the mixing powder is dried in a vacuum condition, the aluminum foil coated with the mixing powder is cut into circular pieces, thereby forming the button lithium ion batteries. A diameter of each of the circular pieces is 8 mm.

### EXAMPLE 4

1280.4 g hydrated lithium hydroxide (LiOH.H₂O) with a purity of 98% and 3000 g TiO₂ with a purity of 99.5% are mixed into 3.0 liter (L) deionized water. After stirring, 214.8 g hydrated barium hydroxide Ba(OH)₂.8H₂O with a purity of 98% is further mixed into the mixing solution of LiOH₂O and TiO₂. After about 5 h stirring, a mixture can be obtained. Next, the mixture is dried by the spray-drying method. Next, the dried mixture is sintered at 750° C. for about 5 h. Then, the lithium titanate doped with the barium oxide can be obtained, which can be directly used as the negative material of the lithium ion battery. In this example, the lithium titanate doped with the barium oxide has the following chemical formula: BaₓLi₄Ti₅O₁₂₊ₓ, wherein x is equal to 0.09. In other words, the weight ratio of the barium oxide and the lithium titanate is 3.0%.

A soft-package lithium ion battery is manufactured by the following steps. 1500.0 g of the lithium titanate doped with the barium oxide, a certain amount of a thickening agent, an adhesive and a conductive agent are mixed to form a mixing slurry. Then, a series of steps including coating the mixing slurry, compressing, cutting pieces, making electrodes, assembling, filling the electrolyte are performed, thereby forming the soft-package lithium ion batteries with 3 ampere-hours(Ah) capacity.

### COMPARISON EXAMPLE 1

1.200 g of the lithium titanate, a certain amount of a conductive agent, an adhesive and n-methyl-2-pyrrolidone (NMP) are mixed for 4 h by a ball-milling method using a planet ball-milling machine, thereby obtaining a mixing powder. Then, the mixing powder is coated on an aluminum foil. A coating thickness of the mixing powder is about 150 μm. After the aluminum foil coated with the mixing powder is dried in a vacuum condition, the aluminum foil coated with the mixing powder is cut into circular pieces, thereby forming the button lithium ion batteries. A diameter of each of the circular pieces is 8 mm.

### COMPARISON EXAMPLE 2

1500.0 g of the lithium titanate, a certain amount of a thickening agent, an adhesive and a conductive agent are mixed to form a mixing slurry. Then, a series of steps including coating the mixing slurry, compressing, cutting pieces, making electrodes, assembling, filling the electrolyte are performed, thereby forming the soft-package lithium ion batteries with 3 Ah capacity.

Charge-discharge tests are applied to the button lithium ion batteries in the examples 1˜3 and the comparison example 1 and the soft-package lithium ion batteries in the example 4 and the comparison example 2. Table 1 show a capacity comparison of the button lithium ion batteries in the examples 1˜3 and the comparison example 1 at room temperature and at 1C and 5C charge-discharge rates. Referring to Table 1, at a low-rate charge-discharge rate (e.g. 1C charge-discharge rate), the capacity of the button lithium ion batteries in the examples 1˜3 is less than the capacity of the button lithium ion battery in comparison example 1. At a high-rate charge-discharge rate (e.g. 5C charge-discharge rate), the capacity of the button lithium ion batteries in the examples 1˜3 is more than the capacity of the button lithium ion battery in the comparison example 1. Thus, the lithium ion battery using the lithium titanate doped with the barium oxide as the negative material can be used at the high-rate charge-discharge rate, which can satisfy the practical demand.

TABLE 1

| | Charge-discharge | |
|---|---|---|
| Example | rate | capacity (mAh/g) |
| Example 1 | 1 C | 139.1 |
| | 5 C | 125.9 |
| Example 2 | 1 C | 155.5 |
| | 5 C | 127.6 |
| Example 4 | 1 C | 143.6 |
| | 5 C | 128.1 |
| Comparison | 1 C | 157.8 |
| Example 1 | 5 C | 120 |

In addition, FIG. 2 illustrates a charge-discharge curve graph of the soft-package lithium ion batteries of two samples (e.g., sample 1 and sample 2) of the example 4 and the comparison example 2 at 60° C. and at 6C charge-discharge rate. Referring to FIG. 2, a cycle life of the soft-package lithium ion batteries of the example 4 is longer than a cycle life of the soft-package lithium ion battery of the comparison example 2. A capacity of the soft-package lithium ion battery of the comparison example 2 after 650 charge-discharge cycles is 80% of original capacity. A capacity of the soft-package lithium ion batteries of the example 4 after 2250 charge-discharge cycles is 80% of original capacity. In other words, the capacity retention rate of the soft-package lithium ion batteries of the example 4 is not less than 80% after 2250 charge-discharge cycles at 60° C. and at 6C charge-discharge rate. Thus, the lithium titanate doped the barium oxide can be used as the negative electrode material of the lithium ion battery serving as an electric vehicle power.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A lithium titanate doped with a barium oxide, having a chemical formula of BaₓLi₄Ti₅O₁₂₊ₓ, wherein 0.006≦x≦0.12.

2. The lithium titanate doped with the barium oxide of claim 1, wherein 0.03≦x≦0.09.

3. A method of manufacturing a lithium titanate doped with a barium oxide, comprising:
preparing a mixture by mixing a barium source material, a lithium source material and a titanium source material;
drying the mixture; and
sintering the mixture after drying the mixture to obtain the lithium titanate doped with the barium oxide having a chemical formula of BaₓLi₄Ti₅O₁₂₊ₓ, wherein 0.006≦x≦0.12.

4. The method of claim 3, wherein the barium source material is at least one of barium hydroxide, barium carbonate, barium oxide and organic barium salt.

5. The method of claim 4, wherein the organic barium salt is at least one of barium oxalate and barium acetate.

6. The method of claim 3, wherein the lithium source material is at least one of lithium hydroxide, lithium carbonate and organic lithium salt.

7. The method of claim 6, wherein the organic lithium salt is at least one of lithium oxalate and lithium acetate.

8. The method of claim 3, wherein the titanium source material is at least one of titanium oxide, metatitanic acid and organic titanate.

9. The method of claim 8, wherein the organic titanate is at least one of isopropyl titanate and n-butyl titanate.

10. The method of claim 3, wherein the drying temperature of drying the mixture is in a range from 80 to 120° C.

11. The method of claim 3, wherein the sintering temperature of sintering the mixture is in a range from 450 to 1000° C.

12. The method of claim 3, wherein the sintering temperature of sintering the mixture is in a range from 500 to 900° C.

13. A lithium ion battery, comprising:
a positive electrode;
a negative electrode comprising a lithium titanate doped with a barium oxide, the lithium titanate doped with the barium oxide having a chemical formula of BaₓLi₄Ti₅O₁₂₊ₓ, wherein 0.006≦x≦0.12;
a separator between the positive electrode and the negative electrode;
and
an electrolyte.

14. The lithium ion battery of claim 13, wherein 0.03≦x≦0.09.

15. The lithium ion battery of claim 13, wherein the positive electrode comprises lithium cobalt(III) oxide (LiCoO₂), lithium iron phosphate (LiFePO₄) or lithium multimetal oxide, and the lithium multimetal oxide has a formula of Li(M1ₓM2_{y}M3_{z}M4₁)O₂, x+y+z+1=1, each of the M1, M2 and M3 is one of nickel, cobalt, manganese and iron, and M4 is aluminum or silicon.
